(19) United States
(12) Patent Application Publication
(10) Pub. No.: US 2025/0123442 A1
(43) Pub. Date: Apr. 17, 2025

(54) OPTICAL DEVICE, OPTICAL RECEIVER, AND OPTICAL TRANSMITTER

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/818,835

(22) Filed: Aug. 29, 2024

(30) Foreign Application Priority Data
Oct. 11, 2023 (JP) 2023-176117

(51) Int. Cl. G02B 6/122

(52) U.S. Cl. CPC G02B 6/1228

(57) ABSTRACT

An optical device includes a first waveguide, and a second waveguide including a region overlapping part of the first waveguide in a vertical direction. The first waveguide includes a first tapered portion, and a second tapered portion that is connected with the end point of the first tapered portion. The second waveguide includes a third waveguide, a fourth waveguide extending along the third waveguide, a first structure in a region overlapping the second tapered portion, the first structure having the third waveguide and the fourth waveguide each increasing in waveguide width as distance from the end point of the first tapered portion increases, and a second structure in a region that is outside the region overlapping the second tapered portion and that is opposite to a region where the first tapered portion is, the second structure having the third waveguide and the fourth waveguide separate from each other.

### CROSS-REFERENCE TO RELATED APPLICATION

This application is based upon and claims the benefit of priority of the prior Japanese Patent Application No. 2023-176117, filed on Oct. 11, 2023, the entire contents of which are incorporated herein by reference.

### FIELD

The embodiments discussed herein are related to optical devices, optical receivers, and optical transmitters.

### BACKGROUND

FIG. 12 is a diagram illustrating an example of a conventional optical chip 100. The optical chip 100 illustrated in FIG. 12 is, for example, an optical IC chip having an optical receiver 110 with a digital coherent function. The optical receiver 110 has: a first edge coupler (EC) 111 arranged at a local light port where local light is input; a second EC 112 arranged at a signal light port where signal light is input; a 1×2 coupler 113; and a polarization beam splitter (PBS) 114. The optical receiver 110 has a polarization rotator (PR) 115, a first optical hybrid circuit 116A, a second optical hybrid circuit 116B, first to eighth photodetectors (PDs) 117A to 117H, and first to eighth output ports 118A to 118H. For example, optical waveguides, such as Si waveguides, connect between the first EC 111 and the first optical hybrid circuit 116A, between the first EC 111 and the second optical hybrid circuit 116B, and between the second EC 112 and the PBS 114.

The first EC 111 at the local light port is an EC for a port formed at a chip edge D11 of the optical chip 100, the port being connected to, for example, a first optical fiber F11 where local light from a light source is input. Forming a chip from a wafer exposes the local light port on the chip edge D11 of the optical chip 100. The second EC 112 at the signal light port is an EC for a port formed at the chip edge D11, which is a lateral edge of the optical chip 100, the port being connected to, for example, a second optical fiber F12 where signal light is input. Forming the chip from the wafer exposes the signal light port on the chip edge D11 of the optical chip 100.

The 1×2 coupler 113 splits and outputs local light input from the first EC 111 into the first optical hybrid circuit 116A and the second optical hybrid circuit 116B. The PBS 114 separates signal light input from the second EC 112 into two polarization states orthogonal to each other, for example, signal light of an X polarization component that is a transverse electric (TE) polarization component and signal light of a Y polarization component that is a transverse magnetic polarization component. The PBS 114 outputs the signal light of the X polarization component to the first optical hybrid circuit 116A. Furthermore, the PR 115 performs polarization rotation of the signal light of the Y polarization component from the PBS 114 by 90 degrees and outputs the converted signal light of the Y polarization component to the second optical hybrid circuit 116B, the converted signal light having been subjected to the polarization rotation.

The first optical hybrid circuit 116A is, for example, a 90-degree hybrid circuit that obtains optical signals of an I component and a Q component by causing the local light to interfere with the signal light of the X polarization component. The I component is an in-phase axis component and the @ component is a quadrature axis component. The first optical hybrid circuit 116A outputs first signal light XIp that is the optical signal of the I component, of the signal light of the X polarization component, to the first PD 117A, and outputs second signal light XIn that is the optical signal of the I component, to the second PD 117B. The first optical hybrid circuit 116A outputs third signal light XOp that is the optical signal of the Q component, of the signal light of the X polarization component, to the third PD 117C, and outputs fourth signal light XOn that is the optical signal of the Q component, to the fourth PD 117D.

The second optical hybrid circuit 116B is, for example, a 90-degree hybrid circuit that obtains optical signals of an I component and a Q component by causing the local light to interfere with the signal light of the Y polarization component. The second optical hybrid circuit 116B outputs fifth signal light YIp that is the optical signal of the I component, of the signal light of the Y polarization component, to the fifth PD 117E, and outputs sixth signal light YIn that is the optical signal of the I component, to the sixth PD 117F. The second optical hybrid circuit 116B outputs seventh signal light YOp that is the optical signal of the Q component, of the signal light of the Y polarization component, to the seventh PD 117G, and outputs eighth signal light YOn that is the optical signal of the Q component, to the PD 117H.

The first PD 117A performs gain adjustment by electric conversion of the first signal light XIp of the I component of the X polarization component from the first optical hybrid circuit 116A, and outputs an electric signal resulting from the gain adjustment, to the first output port 118A. The second PD 117B performs gain adjustment by electric conversion of the second signal light XIn of the I component of the X polarization component from the first optical hybrid circuit 116A, and outputs an electric signal resulting from the gain adjustment, to the second output port 118B. The third PD 117C performs gain adjustment by electric conversion of the third signal light XOp that is the Q component of the X polarization component from the first optical hybrid circuit 116A, and outputs an electric signal resulting from the gain adjustment, to the third output port 118C. The fourth PD 117D performs gain adjustment by electric conversion of the fourth signal light XOn that is the Q component of the X polarization component from the first optical hybrid circuit 116A, and outputs an electric signal resulting from the gain adjustment, to the fourth output port 118D.

The fifth PD 117E performs gain adjustment by electric conversion of the fifth signal light YIp that is the I component of the Y polarization component from the second optical hybrid circuit 116B, and outputs an electric signal resulting from the gain adjustment, to the fifth output port 118E. The sixth PD 117F performs gain adjustment by electric conversion of the sixth signal light YIn that is the I component of the Y polarization component from the second optical hybrid circuit 116B, and outputs an electric signal resulting from the gain adjustment, to the sixth output port 118F. The seventh PD 117G performs gain adjustment by electric conversion of the seventh signal light YOp that is the Q component of the Y polarization component from the second optical hybrid circuit 116B, and outputs an electric signal resulting from the gain adjustment, to the seventh output port 118G. The eighth PD 117H performs gain adjustment by electric conversion of the eighth signal light YOn that is the Q component of the Y polarization component from the second optical hybrid circuit 116B, and outputs an electric signal resulting from the gain adjustment, to the eighth output port 118H.

FIG. 13 is a schematic plan view of an example of part of the first EC 111 in the optical chip 100. The part of the first EC 111 illustrated in FIG. 13 is part of a substrate-type optical waveguide element optically coupled to a core C of the first optical fiber F11. The part of the first EC 111 has the first EC 111 at the local light port. Components of the second EC 112 are the same as those of the first EC 111 and description of the same components and operation thereof will thus be omitted by assignment of the same reference signs.

The first EC 111 has: cladding 121 formed of, for example, SiO₂; and a first waveguide 122 covered with the cladding 121 and formed of, for example, Si₃N₄ (hereinafter, simply referred to as silicon nitride (SiN)). The first EC 111 has: a second waveguide 123 covered with the cladding 121 and formed of, for example, Si; and a heat insulation conversion portion 124 where light undergoes optical transition adiabatically between the first waveguide 122 and the second waveguide 123. Furthermore, the first EC 111 has an inversely tapered portion 125 having a structure with the first waveguide 122 gradually decreasing in waveguide width up to the chip edge D11.

The first waveguide 122 has: a first tapered waveguide 122A; and a second tapered waveguide 122B connected with the first tapered waveguide 122A. The first tapered waveguide 122A has a structure that gradually increases in waveguide width toward an end point of the first tapered waveguide 122A from a start point of the first tapered waveguide 122A, the start point being an optical input-output portion near the chip edge D11. The second tapered waveguide 122B has a structure that gradually decreases in waveguide width from a start point of the second tapered waveguide 122B, as distance from the end point of the first tapered waveguide 122A increases, the start point being where the second tapered waveguide 122B is connected with the end point of the first tapered waveguide 122A.

The second waveguide 123 has: a third tapered waveguide 123A arranged at a position where at least part of the third tapered waveguide 123A overlaps the second tapered waveguide 122B in a vertical direction; and a linear waveguide 123B connected with the third tapered waveguide 123A. The third tapered waveguide 123A has a structure that gradually increases in waveguide width as distance from the start point of the second tapered waveguide 122B increases. The linear waveguide 123B is a waveguide connected with an end of the third tapered waveguide 123A, the end being larger in waveguide width.

FIG. 14A is a schematic diagram illustrating an example of a cross-section on a line A-A illustrated in FIG. 13. The first EC 111 illustrated in FIG. 14A has a Si substrate 131, the cladding 121, a first assembly layer 141A arranged farther from the Si substrate 131, and a second assembly layer 141B arranged closer to the Si substrate 131. The cross section on the line A-A and illustrated in FIG. 14A is a cross section of part of the first EC 111, the part being where the linear waveguide 123B has been arranged. The linear waveguide 123B in the second waveguide 123 has been arranged in the second assembly layer 141B.

FIG. 14B is a diagram schematically illustrating an example of a cross-section on a line B-B illustrated in FIG. 13. The first EC 111 illustrated in FIG. 14B has the Si substrate 131, the cladding 121, the first assembly layer 141A, and the second assembly layer 141B. The cross section on the line B-B and illustrated in FIG. 14B is a cross section of part of the first EC 111, the part being where the heat insulation conversion portion 124 has been arranged. The third tapered waveguide 123A in the second waveguide 123 has been arranged in the second assembly layer 141B. The second tapered waveguide 122B in the first waveguide 122 has been arranged in the first assembly layer 141A.

FIG. 14C is a diagram schematically illustrating an example of a cross-section on a line C-C illustrated in FIG. 13. The first EC 111 illustrated in FIG. 14C has the Si substrate 131, and the cladding 121 layered on the Si substrate 131. The cross section on the line C-C and illustrated in FIG. 14C is a cross section of part of the first EC 111, the part being where the inversely tapered portion 125 has been arranged. Furthermore, the first EC 111 has the first assembly layer 141A and the second assembly layer 141B. The first tapered waveguide 122A in the first waveguide 122 has been arranged in the first assembly layer 141A.

A heat insulation conversion portion 124 and an inversely tapered portion 125 of the second EC 112 are configured in the same way and thus have the same waveguide width, waveguide length, and waveguide thickness as the heat insulation conversion portion 124 and the inversely tapered portion 125 of the first EC 111.

The first EC 111 guides local light from the first optical fiber F11 by use of the inversely tapered portion 125, to the heat insulation conversion portion 124. Waveguide width of the first waveguide 122 and the second waveguide 123 in the heat insulation conversion portion 124 changes in a tapered manner. The first waveguide 122 has a refractive index lower than that of the second waveguide 123, and thus enables: increase in the mode field of the local light; and reduction in coupling loss between the first waveguide 122 and the first optical fiber F11.

The second EC 112 guides received light from the second optical fiber F12 by use of the inversely tapered portion 125, to the heat insulation conversion portion 124. Waveguide width of a first waveguide 122 and a second waveguide 123 in the heat insulation conversion portion 124 changes in a tapered manner. The first waveguide 122 has a refractive index lower than that of the second waveguide 123, and thus enables: increase in the mode field of the received light; and reduction in coupling loss between the first waveguide 122 and the second optical fiber F12.
Patent Literature 1: Japanese National Publication of International Patent Application No. 2017-534926
Patent Literature 2: Japanese Laid-open Patent Publication No. 2022-83779
Patent Literature 3: Japanese National Publication of International Patent Application No. 2019-518987

In the conventional optical chip 100, local light input from the first EC 111 is split by the 1×2 coupler 113 and input to the first optical hybrid circuit 116A and the second optical hybrid circuit 116B. However, space for arranging the 1×2 coupler 113 is of course to be secured in the optical chip 100 and optical loss is generated in the 1×2 coupler 113 when the local light is split by the 1×2 coupler 113.

### SUMMARY

According to an aspect of an embodiment, an optical device includes a first waveguide, and a second waveguide including a region overlapping part of the first waveguide in a vertical direction. The first waveguide includes a first tapered portion and a second tapered portion. The first tapered portion increases in waveguide width from a start point of the first tapered portion toward an end point of the first tapered portion. The second tapered portion is connected with the end point of the first tapered portion and decreases in waveguide width as distance from the first tapered portion increases. The second waveguide includes a third waveguide, a fourth waveguide extending along the third waveguide, a first structure and a second structure. The first structure in a region overlapping the second tapered portion, includes the third waveguide and the fourth waveguide each increasing in waveguide width as distance from the end point of the first tapered portion increases. The second structure in a region that is outside the region overlapping the second tapered portion and that is opposite to a region where the first tapered portion is, includes the third waveguide and the fourth waveguide separate from each other.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an optical chip according to a first embodiment;

FIG. 2 is a schematic plan view of an example of part of a second EC in the optical chip;

FIG. 3A is a diagram schematically illustrating an example of a cross-section on a line A-A illustrated in FIG. 2;

FIG. 3B is a diagram schematically illustrating an example of a cross-section on a line B-B illustrated in FIG. 2;

FIG. 3C is a diagram schematically illustrating an example of a cross-section on a line C-C illustrated in FIG. 2;

FIG. 4 is a schematic plan view of an example of part of a first EC in the optical chip;

FIG. 5A is a diagram schematically illustrating an example of a cross-section on a line A-A illustrated in FIG. 4;

FIG. 5B is a diagram schematically illustrating an example of a cross-section on a line B-B illustrated in FIG. 4;

FIG. 5C is a diagram schematically illustrating an example of a cross-section on a line C-C illustrated in FIG. 4;

FIG. 6 is a schematic plan view of an example of part of a first EC in an optical chip according to a second embodiment;

FIG. 7A is a diagram schematically illustrating an example of a cross-section on a line A-A illustrated in FIG. 6;

FIG. 7B is a diagram schematically illustrating an example of a cross-section on a line B-B illustrated in FIG. 6;

FIG. 7C is a diagram schematically illustrating an example of a cross-section on a line C-C illustrated in FIG. 6;

FIG. 8 is a schematic plan view of an example of part of a first EC in an optical chip according to a third embodiment;

FIG. 9 is a schematic plan view of an example of part of a first EC in an optical chip according to a fourth embodiment;

FIG. 10A is a diagram schematically illustrating an example of a cross-section on a line A-A illustrated in FIG. 9;

FIG. 10B is a diagram schematically illustrating an example of a cross-section on a line B-B illustrated in FIG. 9;

FIG. 10C is a diagram schematically illustrating an example of a cross-section on a line C-C illustrated in FIG. 9;

FIG. 11 is a diagram illustrating an example of an optical transceiver according to an embodiment;

FIG. 12 is a diagram illustrating an example of a conventional optical chip;

FIG. 13 is a schematic plan view of an example of part of a first EC in the optical chip;

FIG. 14A is a diagram schematically illustrating an example of a cross-section on a line A-A illustrated in FIG. 13;

FIG. 14B is a diagram schematically illustrating an example of a cross-section on a line B-B illustrated in FIG. 13; and

FIG. 14C is a diagram schematically illustrating an example of a cross-section on a line C-C illustrated in FIG. 13.

### DESCRIPTION OF EMBODIMENTS

Preferred embodiments of the present invention will be explained with reference to accompanying drawings. The present invention is not to be limited by these embodiments. The following embodiments may be combined with one another as appropriate so long as no contradiction is thereby caused.

### (a) First Embodiment

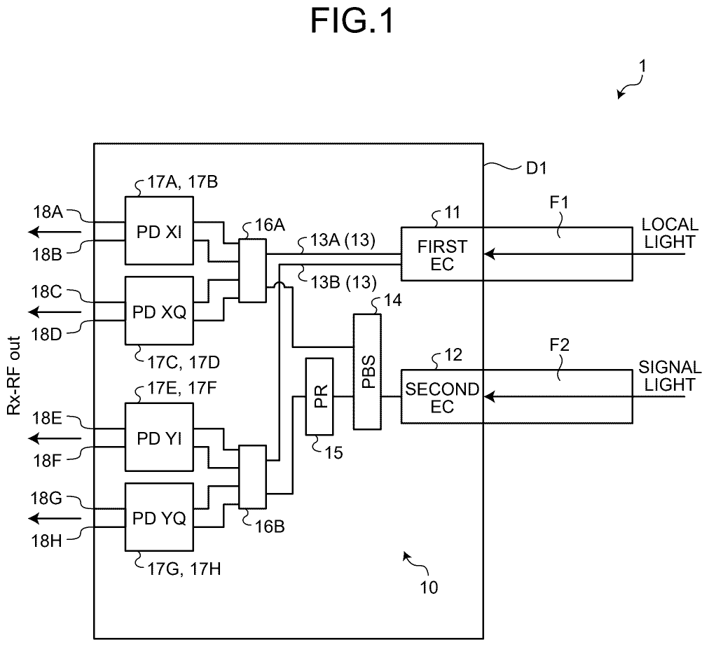

FIG. 1 is a diagram illustrating an example of an optical chip 1 according to a first embodiment. The optical chip 1 illustrated in FIG. 1 is, for example, an optical IC chip having an optical receiver 10 with a digital coherent function. The optical receiver 10 has: a first edge coupler (EC) 11 arranged at a local light port where local light is input; a second EC 12 arranged at a signal light port where signal light is input; and optical waveguides 13. The optical receiver 10 has a polarization beam splitter (PBS) 14 and a polarization rotator (PR) 15. The optical receiver 10 has a first optical hybrid circuit 16A, a second optical hybrid circuit 16B, first to eighth photodetectors (PDs) 17A to 17H, and first to eighth output ports 18A to 18H. For example, the optical waveguides 13, such as Si waveguides, connect between the first EC 11 and the first optical hybrid circuit 16A, between the first EC 11 and the second optical hybrid circuit 16B, and between the second EC 12 and the PBS 14. The optical waveguides 13 include, for example, a first optical waveguide 13A connecting between the first EC 11 and the first optical hybrid circuit 16A, and a second optical waveguide 13B connecting between the first EC 11 and the second optical hybrid circuit 16B.

The first EC 11 at the local light port is an EC for a port formed at a chip edge D1 of the optical chip 1, the port being connected to, for example, a first optical fiber F1 where local light from a light source is input. Forming a chip from a wafer exposes the local light port on the chip edge D1 of the optical chip 1. The second EC 12 at the signal light port is an EC for a port formed at the chip edge D1, which is a lateral edge of the optical chip 1, the port being connected to, for example, a second optical fiber F2 where signal light is input. Forming the chip from the wafer exposes the signal light port on the chip edge D1 of the optical chip 1.

The PBS 14 is polarization multiplexer-demultiplexer that separates signal light input from the second EC 12 into two polarization states orthogonal to each other, for example, signal light of an X polarization component that is a transverse electric (TE) polarization component and signal light of a Y polarization component that is a transverse magnetic polarization component. The PBS 14 outputs the signal light of the X polarization component from the signal light to the first optical hybrid circuit 16A. The PR 15 performs polarization rotation of the signal light of the Y polarization component from the PBS 14 by 90 degrees and outputs the converted signal light of the Y polarization component to the second optical hybrid circuit 16B, the converted signal light having been subjected to the polarization rotation.

The first optical hybrid circuit 16A is, for example, a 90-degree hybrid circuit that obtains optical signals of an I component and a Q component by causing the local light to interfere with the signal light of the X polarization component. The I component is an in-phase axis component and the Q component is a quadrature axis component. The first optical hybrid circuit 16A outputs first signal light XIp that is the optical signal of the I component, of the signal light of the X polarization component, to the first PD 17A and outputs second signal light XIn that is the optical signal of the I component, to the second PD 17B. The first optical hybrid circuit 16A outputs third signal light XOp that is the optical signal of the Q component, of the signal light of the X polarization component, to the third PD 17C, and outputs fourth signal light XOn that is the optical signal of the Q component, to the fourth PD 17D.

The second optical hybrid circuit 16B is, for example, a 90-degree hybrid circuit that obtains optical signals of an I component and a Q component by causing the local light to interfere with the signal light of the Y polarization component. The second optical hybrid circuit 16B outputs fifth signal light YIp that is the optical signal of the I component, of the signal light of the Y polarization component, to the fifth PD 17E, and outputs sixth signal light YIn that is the optical signal of the I component, to the sixth PD 17F. The second optical hybrid circuit 16B outputs seventh signal light YQp that is the optical signal of the Q component, of the signal light of the Y polarization component, to the seventh PD 17G, and outputs eighth signal light YOn that is the optical signal of the Q component, to the PD 17H.

The first PD 17A performs gain adjustment by electric conversion of the first signal light XIp of the I component of the X polarization component from the first optical hybrid circuit 16A, and outputs an electric signal resulting from the gain adjustment, to the first output port 18A. The second PD 17B performs gain adjustment by electric conversion of the second signal light XIn of the I component of the X polarization component from the first optical hybrid circuit 16A and outputs an electric signal resulting from the gain adjustment, to the second output port 18B. The third PD 17C performs gain adjustment by electric conversion of the third signal light XQp that is the Q component of the X polarization component from the first optical hybrid circuit 16A, and outputs an electric signal resulting from the gain adjustment, to the third output port 18C. The fourth PD 17D performs gain adjustment by electric conversion of the fourth signal light XOn that is the Q component of the X polarization component from the first optical hybrid circuit 16A, and outputs an electric signal resulting from the gain adjustment, to the fourth output port 18D.

The fifth PD 17E performs gain adjustment by electric conversion of the fifth signal light YIp that is the I component of the Y polarization component from the second optical hybrid circuit 16B, and outputs an electric signal resulting from the gain adjustment, to the fifth output port 18E. The sixth PD 17F performs gain adjustment by electric conversion of the sixth signal light YIn that is the I component of the Y polarization component from the second optical hybrid circuit 16B, and outputs an electric signal resulting from the gain adjustment, to the sixth output port 18F. The seventh PD 17G performs gain adjustment by electric conversion of the seventh signal light YOp that is the Q component of the Y polarization component from the second optical hybrid circuit 16B, and outputs an electric signal resulting from the gain adjustment, to the seventh output port 18G. The eighth PD 17H performs gain adjustment by electric conversion of the eighth signal light YOn that is the Q component of the Y polarization component from the second optical hybrid circuit 16B and outputs an electric signal resulting from the gain adjustment, to the eighth output port 18H.

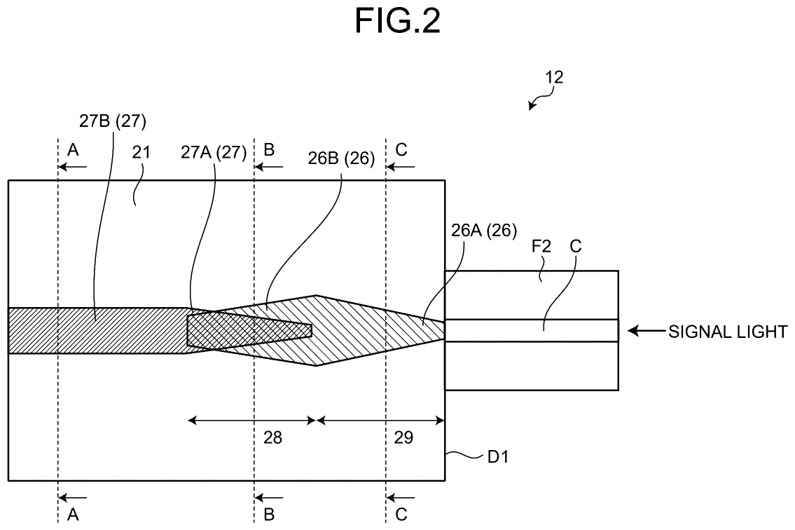

FIG. 2 is a schematic plan view of an example of part of the second EC 12 in the optical chip 1. The second EC 12 illustrated in FIG. 2 is an EC, such as a substrate-type optical waveguide element optically coupled to a core C of the second optical fiber F2. Signal light is input to the second EC 12 from the second optical fiber F2. This signal light includes, for example, TE light and TM light.

The second EC 12 has: cladding 21 formed of, for example, SiO₂; and a fifth waveguide 26 covered with the cladding 21 and formed of, for example, Si₃N₄ (hereinafter, simply referred to as silicon nitride (SiN)). The second EC 12 has: a sixth waveguide 27 covered with the cladding 21 and formed of, for example, Si; and a second heat insulation conversion portion 28 where light undergoes optical transition adiabatically between the fifth waveguide 26 and the sixth waveguide 27. Furthermore, the second EC 12 has a second inversely tapered portion 29 having a structure with the fifth waveguide 26 gradually decreasing in waveguide width up to the chip edge D1. The second inversely tapered portion 29 is a tapered portion that guides signal light from the second optical fiber F2 connected to the chip edge D1, the tapered portion being included in the second EC 12.

The fifth waveguide 26 has a first tapered waveguide 26A, and a second tapered waveguide 26B connected with the first tapered waveguide 26A. The first tapered waveguide 26A has a structure that gradually increases in waveguide width toward an end point of the first tapered waveguide 26A from a start point of the first tapered waveguide 26A, the start point being an optical input-output portion near the chip edge D1. The second tapered waveguide 26B has a structure that gradually decreases in waveguide width from a start point as distance from the end point of the first tapered waveguide 26A increases, the start point being where the second tapered waveguide 26B is connected with the end point of the first tapered waveguide 26A.

The sixth waveguide 27 has: a third tapered waveguide 27A arranged at a position where at least part of the third tapered waveguide 27A overlaps the second tapered waveguide 26B in a vertical direction; and a linear waveguide 27B connected with the third tapered waveguide 27A. This vertical direction is a depth direction of the drawing in FIG. 2. The third tapered waveguide 27A has a structure that gradually increases in waveguide width as distance from the start point of the second tapered waveguide 26B increases. The linear waveguide 27B is a waveguide connected with an end of the third tapered waveguide 27A, the end being larger in waveguide width.

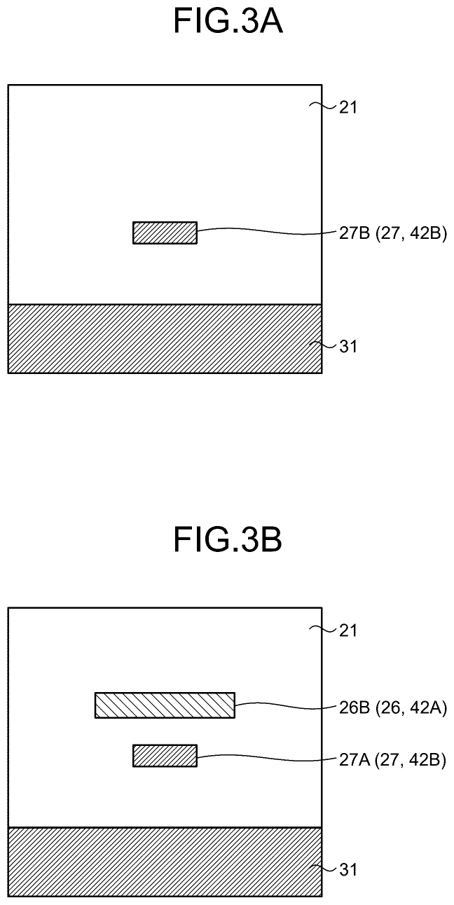

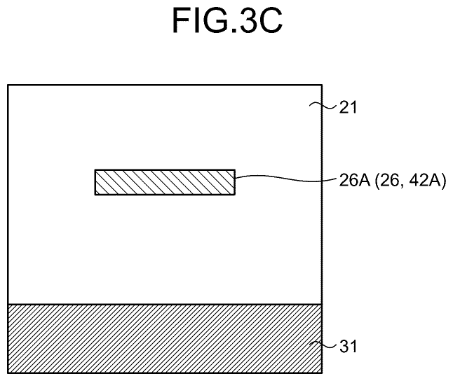

FIG. 3A is a schematic diagram illustrating an example of a cross-section on a line A-A illustrated in FIG. 2. The second EC 12 illustrated in FIG. 3A has: a Si substrate 31; cladding 21; a first assembly layer 42A arranged farther from the Si substrate 31; and a second assembly layer 42B arranged closer to the Si substrate 31. The cross section on the line A-A and illustrated in FIG. 3A is a cross section of part of the second EC 12, the part being where the linear waveguide 27B has been arranged. The linear waveguide 27B in the sixth waveguide 27 has been arranged in the second assembly layer 42B.

FIG. 3B is a schematic diagram illustrating an example of a cross-section on a line B-B illustrated in FIG. 2. The second EC 12 illustrated in FIG. 3B has the Si substrate 31, the cladding 21, the first assembly layer 42A, and the second assembly layer 42B. The cross section on the line B-B and illustrated in FIG. 3B is a cross section of part of the second EC 12, the part being where the second heat insulation conversion portion 28 has been arranged. The third tapered waveguide 27A in the sixth waveguide 27 has been arranged in the second assembly layer 42B. The second tapered waveguide 26B in the fifth waveguide 26 has been arranged in the first assembly layer 42A.

FIG. 3C is a schematic diagram illustrating an example of a cross-section on a line C-C illustrated in FIG. 2. The second EC 12 illustrated in FIG. 3C has the Si substrate 31 and the cladding 21 layered on the Si substrate 31. The cross section on the line C-C and illustrated in FIG. 3C is a cross section of part of the second EC 12, the part being where the second inversely tapered portion 29 has been arranged. Furthermore, the second EC 12 has the first assembly layer 42A and the second assembly layer 42B. The first tapered waveguide 26A in the fifth waveguide 26 has been arranged in the first assembly layer 42A.

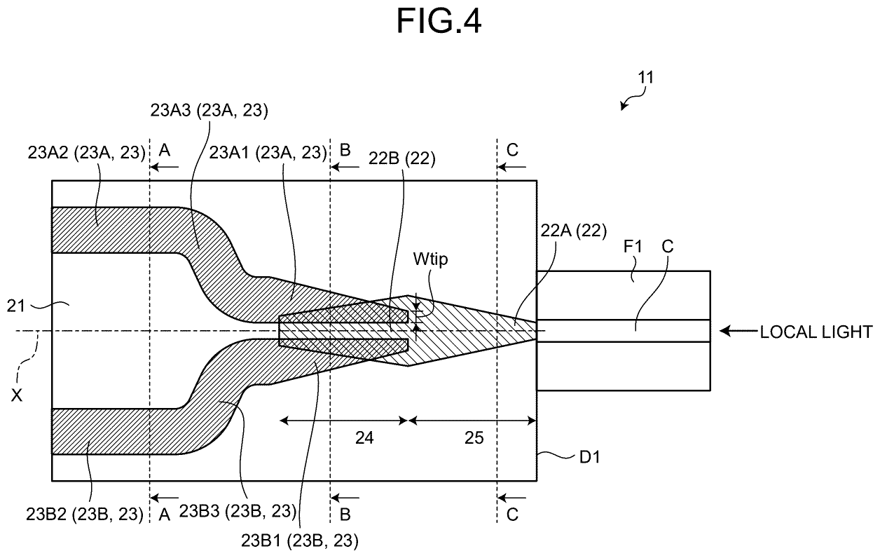

FIG. 4 is a schematic plan view of an example of part of the first EC 11 in the optical chip 1. The first EC 11 illustrated in FIG. 4 is an EC, such as a substrate-type optical waveguide element optically coupled to a core C of the first optical fiber F1. Local light is input to the first EC 11 from the first optical fiber F1. This local light is, for example, TE light.

The first EC 11 has: cladding 21 formed of, for example, SiO₂; a first waveguide 22 covered with the cladding 21 and formed of, for example, SiN; and a second waveguide 23 covered with the cladding 21 and formed of, for example, Si. The first EC 11 is an optical device having: the first waveguide 22; and the second waveguide 23 including a region overlapping part of the first waveguide 22 in a vertical direction. The first EC 11 has a first heat insulation conversion portion 24 where light undergoes optical transition adiabatically between the first waveguide 22 and the second waveguide 23. Furthermore, the first EC 11 has a first inversely tapered portion 25 where the first waveguide 22 has a structure that gradually decreases in waveguide width up to the chip edge D1. The first inversely tapered portion 25 is a tapered portion that guides local light from the first optical fiber F1 connected to the chip edge D1, the tapered portion being included in the first EC 11.

The first waveguide 22 has a first tapered waveguide 22A, and a second tapered waveguide 22B connected with the first tapered waveguide 22A. The first tapered waveguide 22A is a first tapered portion having a structure that gradually increases in waveguide width toward an end point of the first tapered waveguide 22A from a start point of the first tapered waveguide 22A, the start point being an optical input-output portion near the chip edge D1. The second tapered waveguide 22B is a second tapered portion having a structure that gradually decreases in waveguide width as distance from the end point of the first tapered waveguide 22A increases, from a start point of the second tapered waveguide 22B, the start point being where the second tapered waveguide 22B is connected with the end point of the first tapered waveguide 22A.

The second waveguide 23 has: a third waveguide 23A; and a fourth waveguide 23B extending along the third waveguide 23A. In a region overlapping the second tapered waveguide 22B, the second waveguide 23 has a structure with the third waveguide 23A and the fourth waveguide 23B each increasing in waveguide width as distance from the end point of the first tapered waveguide 22A increases. The second waveguide 23 has a structure with the third waveguide 23A and the fourth waveguide 23B being separate from each other in a region that is outside the region overlapping the second tapered waveguide 22B and that is opposite to a region where the first tapered waveguide 22A is. The third waveguide 23A has: a tapered waveguide 23A1; a linear waveguide 23A1; and an approximately S-shaped waveguide 23A3 connecting the tapered waveguide 23A1 and the linear waveguide 23A2 to each other. The tapered waveguide 23A1 is connected with one end of the approximately S-shaped waveguide 23A3. The approximately

S-shaped waveguide 23A3 is connected with one end of the linear waveguide 23A2. The linear waveguide 23A2 is connected to the first optical waveguide 13A. The fourth waveguide 23B has: a tapered waveguide 23B1; a linear waveguide 23B2; and an approximately S-shaped waveguide 23B3 connecting the tapered waveguide 23B1 and the linear waveguide 23B2 to each other. The tapered waveguide 23B1 is connected with one end of the approximately S-shaped waveguide 23B3. The approximately S-shaped waveguide 23B3 is connected with one end of the linear waveguide 23B2. The linear waveguide 23B2 is connected to the second optical waveguide 13B.

The tapered waveguide 23A1 is arranged at a position where at least part of the tapered waveguide 23A1 overlaps the second tapered waveguide 22B in the vertical direction. The tapered waveguide 23A1 has a structure that gradually increases in waveguide width as distance from the start point of the second tapered waveguide 22B increases. The tapered waveguide 23B1 is arranged at a position where at least part of the tapered waveguide 23B1 overlaps the second tapered waveguide 22B in the vertical direction. The tapered waveguide 23B1 has a structure that gradually increases in waveguide width as distance from the start point of the second tapered waveguide 22B increases. The interval between the tapered waveguide 23A1 and the tapered waveguide 23B1 is constant.

The first waveguide 22 and the second waveguide 23 are structured to be line-symmetric about a central axis X of the first waveguide 22 illustrated in FIG. 4 and thus enable splitting, as a 1×2 coupler function, of local light input from the first waveguide 22.

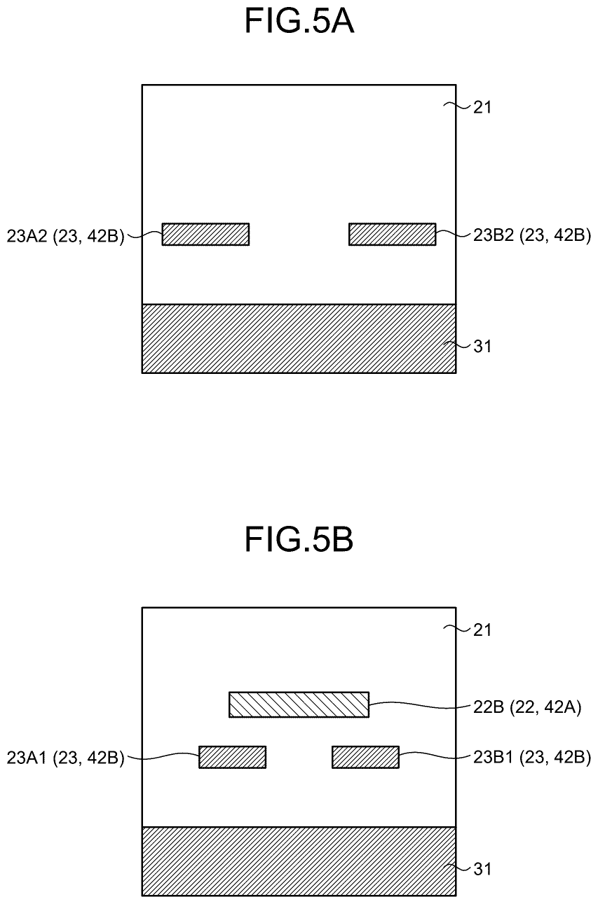

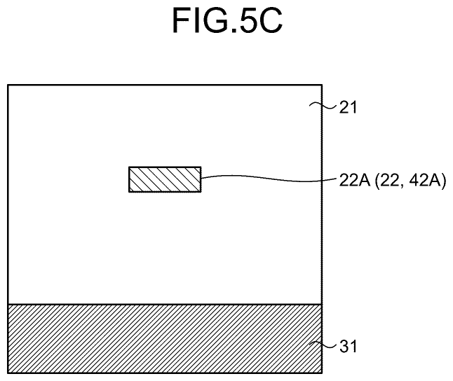

FIG. 5A is a schematic diagram illustrating an example of a cross-section on a line A-A illustrated in FIG. 4. The first EC 11 illustrated in FIG. 5A has: a Si substrate 31; cladding 21; a first assembly layer 42A arranged farther from the Si substrate 31; and a second assembly layer 42B arranged closer to the Si substrate 31. The cross section on the line A-A and illustrated in FIG. 5A is a cross section of part of the first EC 11, the part being where the linear waveguides 23A2 and 23B2 have been arranged. The linear waveguide 23A2 in the third waveguide 23A and the linear waveguide 23B2 in the fourth waveguide 23B have been arranged in the second assembly layer 42B.

FIG. 5B is a schematic diagram illustrating an example of a cross-section on a line B-B illustrated in FIG. 4. The first EC 11 illustrated in FIG. 5B has the Si substrate 31, the cladding 21, the first assembly layer 42A, and the second assembly layer 42B. The cross section on the line B-B and illustrated in FIG. 5B is a cross section of part of the first EC 11, the part being where the first heat insulation conversion portion 24 has been arranged. The tapered waveguide 23A1 in the third waveguide 23A and the tapered waveguide 23B1 in the fourth waveguide 23B have been arranged in the second assembly layer 42B. The second tapered waveguide 22B in the first waveguide 22 has been arranged in the first assembly layer 42A.

FIG. 5C is a schematic diagram illustrating an example of a cross-section on a line C-C illustrated in FIG. 4. The first EC 11 illustrated in FIG. 5C has the Si substrate 31, and the cladding 21 layered on the Si substrate 31. The cross section on the line C-C and illustrated in FIG. 5C is a cross section of part of the first EC 11, the part being where the first inversely tapered portion 25 has been arranged. Furthermore, the first EC 11 has the first assembly layer 42A and the second assembly layer 42B. The first tapered waveguide 22A in the first waveguide 22 has been arranged in the first assembly layer 42A.

The second EC 12 illustrated in FIG. 2 guides signal light from the second optical fiber F2 to the second heat insulation conversion portion 28 by using the second inversely tapered portion 29. The fifth waveguide 26 and the sixth waveguide 27 in the second heat insulation conversion portion 28 change in waveguide width in a tapered manner. Because the fifth waveguide 26 has a refractive index lower than that of the sixth waveguide 27, the mode field of the signal light is able to be increased and coupling loss between the fifth waveguide 26 and the second optical fiber F2 is able to be reduced.

The first EC 11 guides local light from the first optical fiber F1 to the first heat insulation conversion portion 24 by using the first inversely tapered portion 25. The first waveguide 22 and the second waveguide 23 in the first heat insulation conversion portion 24 change in waveguide width in a tapered manner. Because the first waveguide 22 has a refractive index lower than that of the second waveguide 23, the mode field of the local light is able to be increased and coupling loss between the first waveguide 22 and the first optical fiber F1 is able to be reduced.

The second waveguide 23 in the first EC11 according to the first embodiment has the third waveguide 23A, and the fourth waveguide 23B extending along the third waveguide 23A. In the region where the second waveguide 23 overlaps part of the second tapered waveguide 22B in the vertical direction, the second waveguide 23 has a structure that increases in waveguide width from one end of the third waveguide 23A and fourth waveguide 23B. Furthermore, in the second waveguide 23, the third waveguide 23A connected to the first optical waveguide 13A and the fourth waveguide 23B connected to the second optical waveguide 13B are separate from each other in the region that is outside the region overlapping the second tapered waveguide 22B and that is opposite to the region where the first tapered waveguide 22A is. As a result, the first EC 11 enables local light to be split to the third waveguide 23A and the fourth waveguide 23B without additional arrangement of a 1×2 coupler and thus enables optical loss to be minimized.

In the first EC 11 according to the first embodiment, if waveguide widths of the third waveguide 23A and fourth waveguide 23B at tips of the third waveguide 23A and fourth waveguide 23B become large due to manufacturing process errors, optical loss due to scattering loss in any discontinuous portion between the first waveguide 22 and the second waveguide 23 may increase. A second embodiment described hereinafter is thus an embodiment to address this situation.

### (b) Second Embodiment

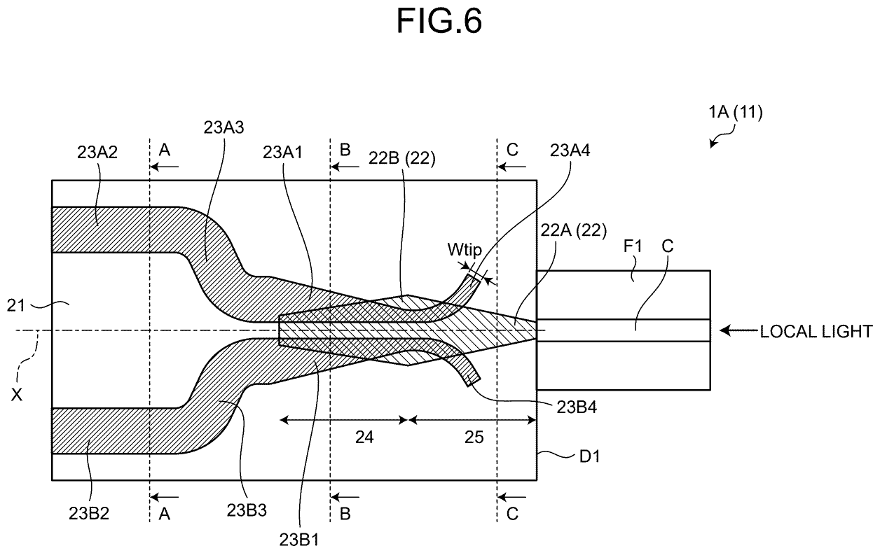

FIG. 6 is a schematic plan view of an example of part of a first EC 11 in an optical chip 1A according to the second embodiment. By assignment of the same reference signs to components that are the same as those of the optical chip 1 according to the first embodiment, description of the same components and operation thereof will be omitted. The optical chip 1A is different from the optical chip 1 in that a tip portion of a tapered waveguide 23A1 and a tip portion of a tapered waveguide 23B1 have been arranged from a start point of a second tapered waveguide 22B to points outside a first tapered waveguide 22A, via a region overlapping the first tapered waveguide 22A.

A third waveguide 23A has: the tapered waveguide 23A1; a linear waveguide 23A2; an approximately S-shaped waveguide 23A3; and a tip waveguide 23A4. The tip waveguide 23A4 is connected with the tapered waveguide 23A1, and is arranged from the start point of the second tapered waveguide 22B to a position separate from the first tapered waveguide 22A, via a position overlapping the first tapered waveguide 22A. Because a tip of the tip waveguide 23A4 is separate from a position overlapping a first waveguide 22, even if a waveguide width Wtip of the tip waveguide 23A4 becomes large due to a process error, increase in optical loss due to the process error is able to be minimized.

A fourth waveguide 23B has: the tapered waveguide 23B1; a linear waveguide 23B2; an approximately S-shaped waveguide 23B3; and a tip waveguide 23B4. The tip waveguide 23B4 is connected with the tapered waveguide 23B1, and is arranged from the start point of the second tapered waveguide 22B to a position separate from the first tapered waveguide 22A, via a position overlapping the first tapered waveguide 22A. Because a tip of the tip waveguide 23B4 is separate from a position overlapping the first waveguide 22, even if a waveguide width Wtip of the tip waveguide 23B4 becomes large due to a process error, increase in optical loss due to the process error is able to be minimized.

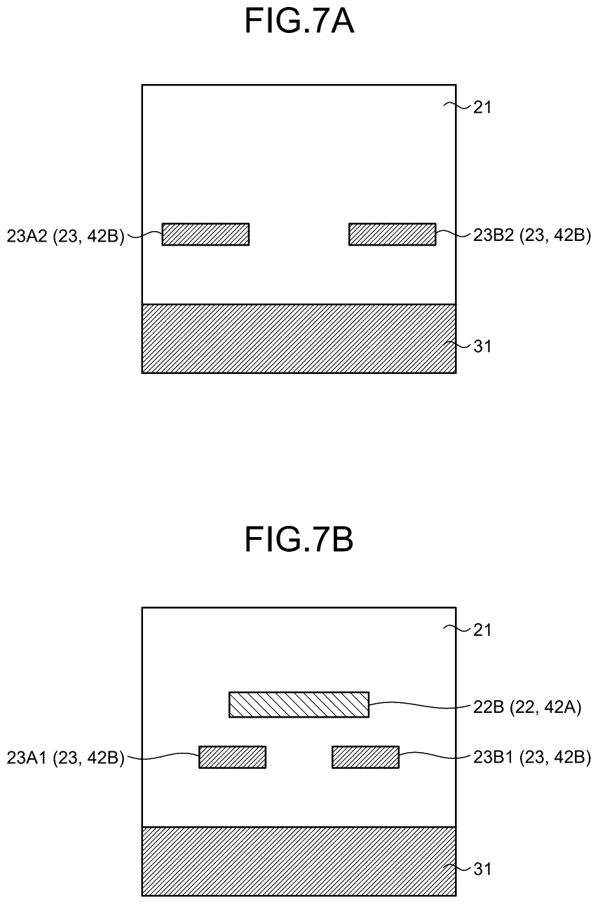

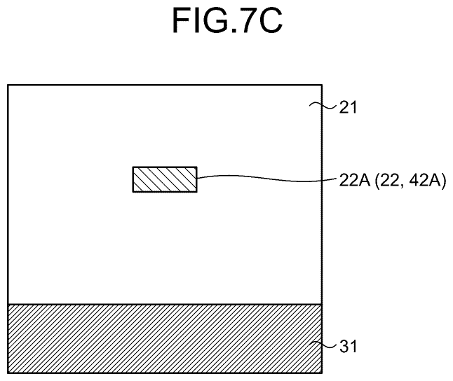

FIG. 7A is a schematic diagram illustrating an example of a cross-section on a line A-A illustrated in FIG. 6. The first EC 11 illustrated in FIG. 7A has a Si substrate 31, cladding 21, a first assembly layer 42A arranged farther from the Si substrate 31, and a second assembly layer 42B arranged closer to the Si substrate 31. The cross section on the line A-A and illustrated in FIG. 7A is a cross section of part of the first EC 11, the part being where the linear waveguides 23A2 and 23B2 have been arranged. The linear waveguide 23A2 in the third waveguide 23A and the linear waveguide 23B2 in the fourth waveguide 23B have been arranged in the second assembly layer 42B.

FIG. 7B is a schematic diagram illustrating an example of a cross-section on a line B-B illustrated in FIG. 6. The first EC 11 illustrated in FIG. 7B has the Si substrate 31, the cladding 21, the first assembly layer 42A, and the second assembly layer 42B. The cross section on the line B-B and illustrated in FIG. 7B is a cross section of part of the first EC 11, the part being where a first heat insulation conversion portion 24 has been arranged. The tapered waveguide 23A1 in the third waveguide 23A and the tapered waveguide 23B1 in the fourth waveguide 23B have been arranged in the second assembly layer 42B. The second tapered waveguide 22B in the first waveguide 22 has been arranged in the first assembly layer 42A.

FIG. 7C is a schematic diagram illustrating an example of a cross-section on a line C-C illustrated in FIG. 6. The first EC 11 illustrated in FIG. 7C has the Si substrate 31, and the cladding 21 layered on the Si substrate 31. The cross section on the line C-C and illustrated in FIG. 7C is a cross section of part of the first EC 11, the part being where a first inversely tapered portion 25 has been arranged. Furthermore, the first EC 11 has the first assembly layer 42A and the second assembly layer 42B. The first tapered waveguide 22A in the first waveguide 22 has been arranged in the first assembly layer 42A.

The first waveguide 22 and a second waveguide 23 are structured to be line-symmetric about a central axis X of the first waveguide 22 illustrated in FIG. 6 and thus enable splitting, as a 1×2 coupler function, of local light input from the first waveguide 22.

In the first EC 11 according to the second embodiment, the tips of the tip waveguide 23A4 and tip waveguide 23B4 are arranged at positions separate from the first tapered waveguide 22A, from a region overlapping the second tapered waveguide 22B via the region overlapping the first tapered waveguide 22A. As a result, tip portions of the second waveguide 23 are not at positions overlapping the first waveguide 22 and influence of scattering loss is thus eliminated. As a result, even if process errors are generated in the waveguide widths of the second waveguide 23 at the tips, increase in optical loss due to the process errors is able to be minimized.

Without being limited to the configuration of the first EC 11 according to the second embodiment, modifications can be made, as appropriate. A third embodiment will thus be described hereinafter as another embodiment.

### (c) Third Embodiment

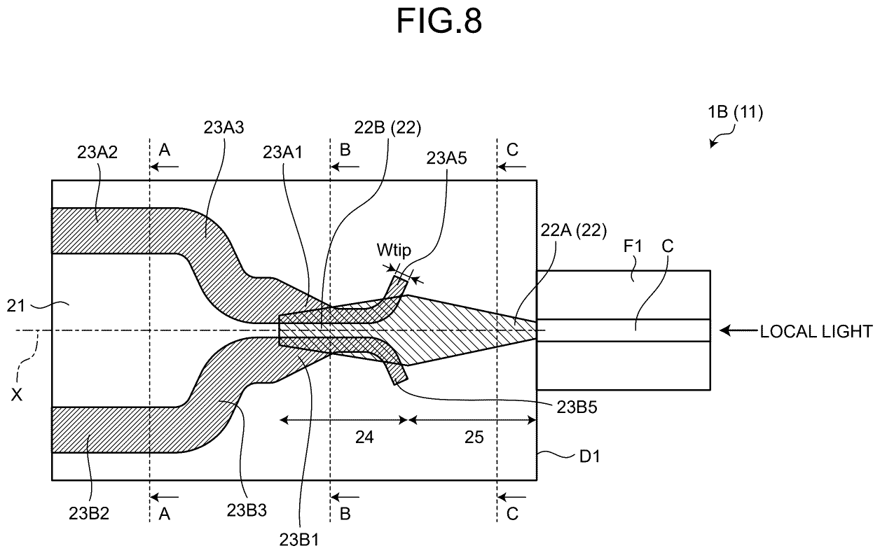

FIG. 8 is a schematic plan view of an example of part of a first EC 11 in an optical chip 1B according to the third embodiment. By assignment of the same reference signs to components that are the same as those of the optical chip 1A according to the second embodiment, description of the same components and operation thereof will be omitted. The optical chip 1B is different from the optical chip 1A in that a tip portion of a tapered waveguide 23A1 of a third waveguide 23A and a tip portion of a tapered waveguide 23B1 of a fourth waveguide 23B are arranged from a start point of a second tapered waveguide 22B to points outside the second tapered waveguide 22B.

The third waveguide 23A has: the tapered waveguide 23A1; a linear waveguide 23A2; an approximately S-shaped waveguide 23A3; and a tip waveguide 23A5. The tip waveguide 23A5 is connected with the tapered waveguide 23A1, arranged at a position overlapping the start point of the second tapered waveguide 22B, and arranged near a lateral surface of the second tapered waveguide 22B and outside the second tapered waveguide 22B. Because a tip of the tip waveguide 23A5 is separate from a position overlapping a first waveguide 22, even if a waveguide width Wtip of the tip waveguide 23A5 becomes large due to a process error, increase in optical loss due to the process error is able to be minimized.

The fourth waveguide 23B has: the tapered waveguide 23B1; a linear waveguide 23B2; an approximately S-shaped waveguide 23B3; and a tip waveguide 23B5. The tip waveguide 23B5 is connected with the tapered waveguide 23B1, arranged at a position overlapping the start point of the second tapered waveguide 22B, and arranged near a lateral surface of the second tapered waveguide 22B and outside the second tapered waveguide 22B. Because a tip of the tip waveguide 23B5 is separate from a position overlapping the first waveguide 22, even if a waveguide width Wtip of the tip waveguide 23B5 becomes large due to a process error, increase in optical loss due to the process error is able to be minimized.

The first waveguide 22 and a second waveguide 23 are structured to be line-symmetric about a central axis X of the first waveguide 22 illustrated in FIG. 8 and thus enable splitting, as a 1×2 coupler function, of local light input from the first waveguide 22.

In the first EC 11 according to the third embodiment, the tip of the tip waveguide 23A5 in the third waveguide 23A and the tip of the tip waveguide 23B5 in the fourth waveguide 23B are arranged from a region overlapping the second tapered waveguide 22B to positions separate from the second tapered waveguide 22B. As a result, tip portions of the second waveguide 23 are not at the positions overlapping the first waveguide 22, and influence of scattering loss is thus eliminated. As a result, even if process errors are generated in the waveguide widths of the second waveguide 23 at the tips, increase in optical loss due to the process errors is able to be minimized.

In the optical chip 1A according to the second embodiment, if the interval between the tapered waveguide 23A1 in the third waveguide 23A and the tapered waveguide 23B1 in the fourth waveguide 23B is made constant, the waveguide lengths of the third waveguide 23A and the fourth waveguide 23B may become long. A fourth embodiment described hereinafter is thus an embodiment to address this situation.

### (d) Fourth Embodiment

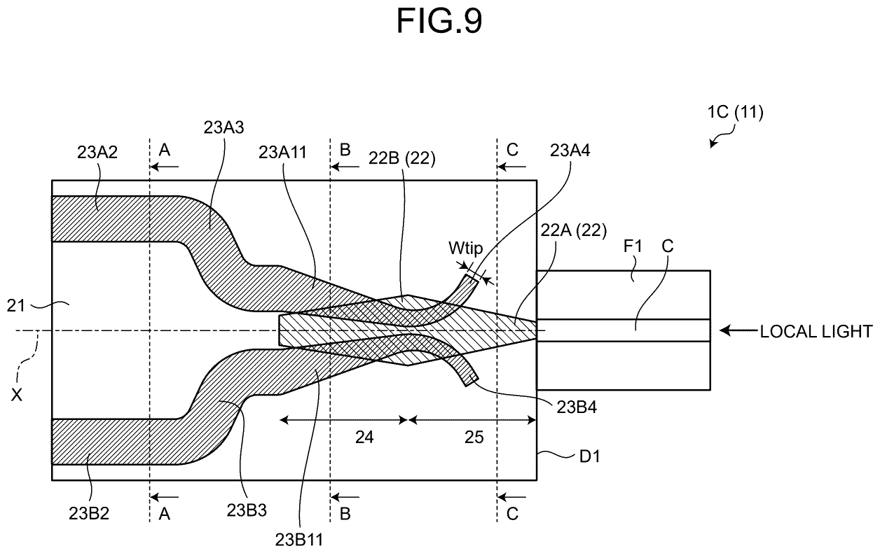

FIG. 9 is a schematic plan view of an example of part of a first EC 11 in an optical chip 1C according to the fourth embodiment. By assignment of the same reference signs to components that are the same as those of the optical chip 1A according to the second embodiment, description of the same components and operation thereof will be omitted. The optical chip 1C according to the fourth embodiment is different from the optical chip 1A according to the second embodiment in that an interval between a tapered waveguide 23A11 in a third waveguide 23A and a tapered waveguide 23B11 in a fourth waveguide 23B gradually increases from a start point to an end point of a second tapered waveguide 22B.

The third waveguide 23A has: the tapered waveguide 23A11; a linear waveguide 23A2; an approximately S-shaped waveguide 23A3; and a tip waveguide 23A4. The tapered waveguide 23A11 is arranged at a position overlapping the second tapered waveguide 22B in a vertical direction. The tapered waveguide 23A11 is connected with one end of the approximately S-shaped waveguide 23A3. The approximately S-shaped waveguide 23A3 is connected with one end of the linear waveguide 23A2. The linear waveguide 23A2 is connected to the first optical waveguide 13A.

The fourth waveguide 23B has: the tapered waveguide 23B11; a linear waveguide 23B2; an approximately S-shaped waveguide 23B3; and a tip waveguide 23B4. The tapered waveguide 23B11 is arranged at a position overlapping the second tapered waveguide 22B in a vertical direction. The tapered waveguide 23B11 is connected with one end of the approximately S-shaped waveguide 23B3. The approximately S-shaped waveguide 23B3 is connected with one end of the linear waveguide 23B2. The linear waveguide 23B2 is connected to the second optical waveguide 13B.

The interval between the tapered waveguide 23A11 in the third waveguide 23A and the tapered waveguide 23B11 in the fourth waveguide 23B gradually increases from the start point to the end point of the second tapered waveguide 22B. As a result, part of the tapered waveguide 23A11 and the tapered waveguide 23B11 is composed of a first heat insulation conversion portion 24, the part overlapping the second tapered waveguide 22B. Furthermore, the interval between the tapered waveguide 23A11 and the tapered waveguide 23B11 at the end point of the second tapered waveguide 22B is larger, and local light from a first waveguide 22 is thus optically split in a 1×2 manner.

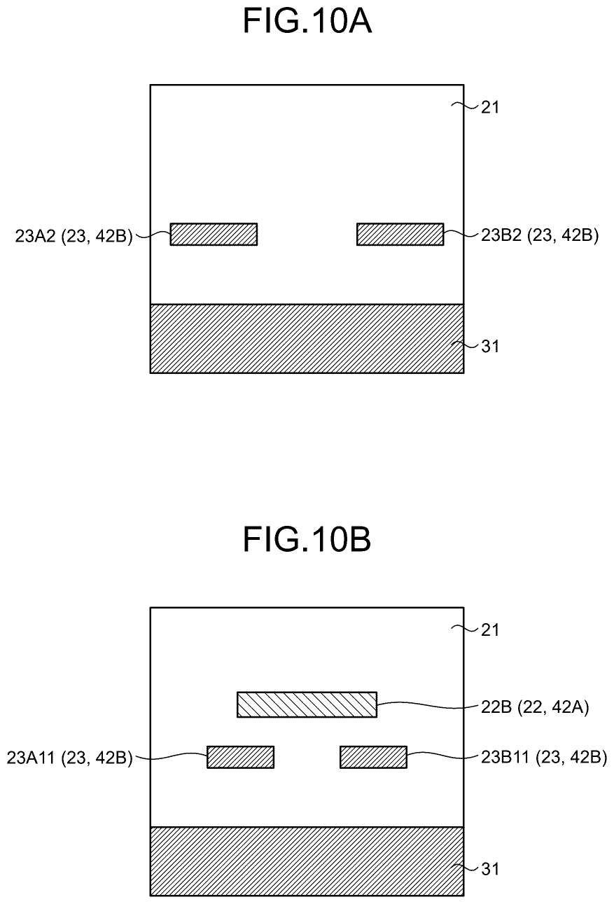

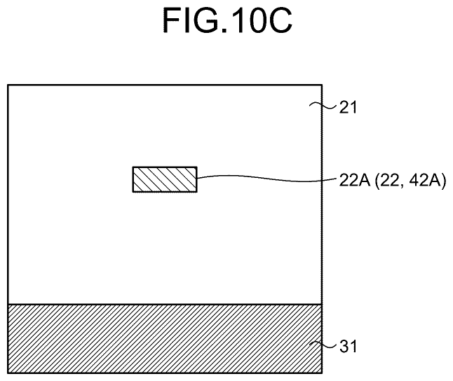

FIG. 10A is a schematic diagram illustrating an example of a cross-section on a line A-A illustrated in FIG. 9. The first EC 11 illustrated in FIG. 10A has a Si substrate 31, cladding 21, a first assembly layer 42A arranged farther from the Si substrate 31, and a second assembly layer 42B arranged closer to the Si substrate 31. The cross section on the line A-A and illustrated in FIG. 10A is a cross section of part of the first EC 11, the part being where the linear waveguides 23A2 and 23B2 have been arranged. The linear waveguide 23A2 in the third waveguide 23A and the linear waveguide 23B2 in the fourth waveguide 23B have been arranged in the second assembly layer 42B.

FIG. 10B is a schematic diagram illustrating an example of a cross-section on a line B-B illustrated in FIG. 9. The first EC 11 illustrated in FIG. 10B has the Si substrate 31, the cladding 21, the first assembly layer 42A, and the second assembly layer 42B. The cross section on the line B-B and illustrated in FIG. 10B is a cross section of part of the first EC 11, the part being where the first heat insulation conversion portion 24 has been arranged. The tapered waveguide 23A11 in the third waveguide 23A and the tapered waveguide 23B11 in the fourth waveguide 23B have been arranged in the second assembly layer 42B. The second tapered waveguide 22B in the first waveguide 22 has been arranged in the first assembly layer 42A.

FIG. 10C is a schematic diagram illustrating an example of a cross-section on a line C-C illustrated in FIG. 9. The first EC 11 illustrated in FIG. 10C has the Si substrate 31 and the cladding 21 layered on the Si substrate 31. The cross section on the line C-C and illustrated in FIG. 10C is a cross section of part of the first EC 11, the part being where a first inversely tapered portion 25 has been arranged. Furthermore, the first EC 11 has the first assembly layer 42A and the second assembly layer 42B. A first tapered waveguide 22A in the first waveguide 22 has been arranged in the first assembly layer 42A.

The first waveguide 22 and a second waveguide 23 are structured to be line-symmetric about a central axis X of the first waveguide 22 illustrated in FIG. 9 and thus enable splitting, as a 1×2 coupler function, of local light input from the first waveguide 22.

In the first EC 11 according to the fourth embodiment, the interval between the tapered waveguide 23A11 in the third waveguide 23A and the tapered waveguide 23B11 in the fourth waveguide 23B gradually increases from the start point to the end point of the second tapered waveguide 22B. As a result, part of the tapered waveguide 23A11 and the tapered waveguide 23B11 is composed of the first heat insulation conversion portion 24, the part overlapping the second tapered waveguide 22B. Furthermore, the interval between the tapered waveguide 23A11 and the tapered waveguide 23B11 at the end point of the second tapered waveguide 22B is larger, and local light from the first waveguide 22 is thus optically split in a 1×2 manner. Therefore, the waveguide lengths of the third waveguide 23A and the fourth waveguide 23B are able to be made shorter.

For the optical chips 1, 1A, 1B, and 1C according to the first to fourth embodiments, a case where optical splitting is implemented between the first EC 11 and the first optical hybrid circuit 16A and second optical hybrid circuit 16B of the optical receiver has been described as an example, but the embodiments may be applied to a 1×2 coupler to be used in a Mach-Zehnder modulator of an optical modulator.

The first waveguide 22, the second waveguide 23, the third waveguide 23A, and the fourth waveguide 23B may be modified as appropriate and may be, for example, channel waveguides, rib waveguides, or ridge waveguides.

An example, in which the first waveguide 22 is a SiN waveguide and the second waveguide 23 is a Si waveguide, has been described with respect to the embodiments, but materials of the first waveguide 22 and the second waveguide 23 may be modified as appropriate. For example, the first waveguide 22 may be a LiNbO₃ (LN) waveguide and the second waveguide 23 may be a Si waveguide, or the first waveguide 22 may be an LN waveguide and the second waveguide 23 may be a SiN waveguide.

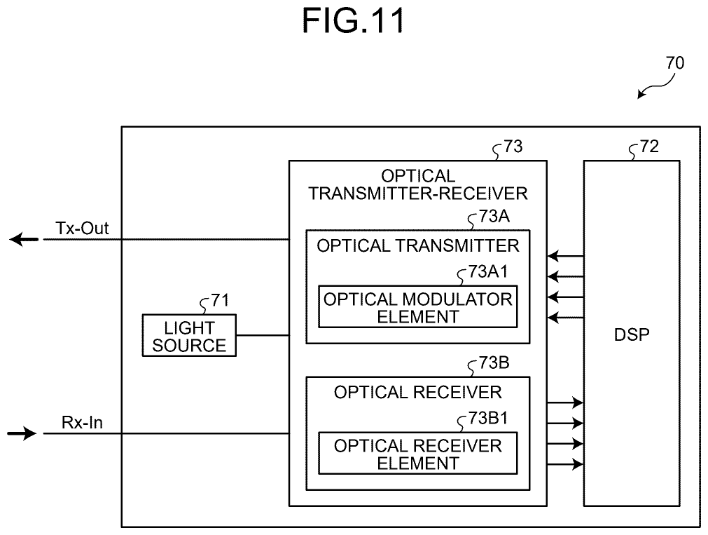

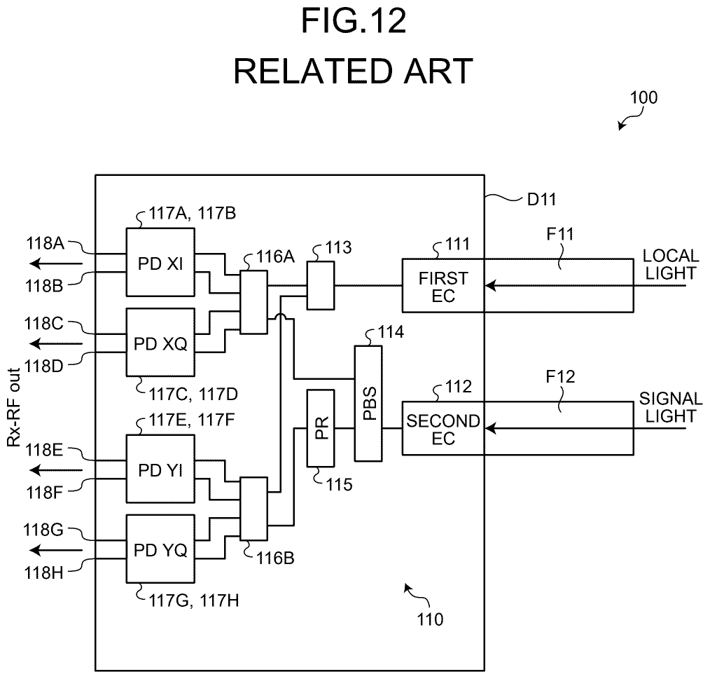

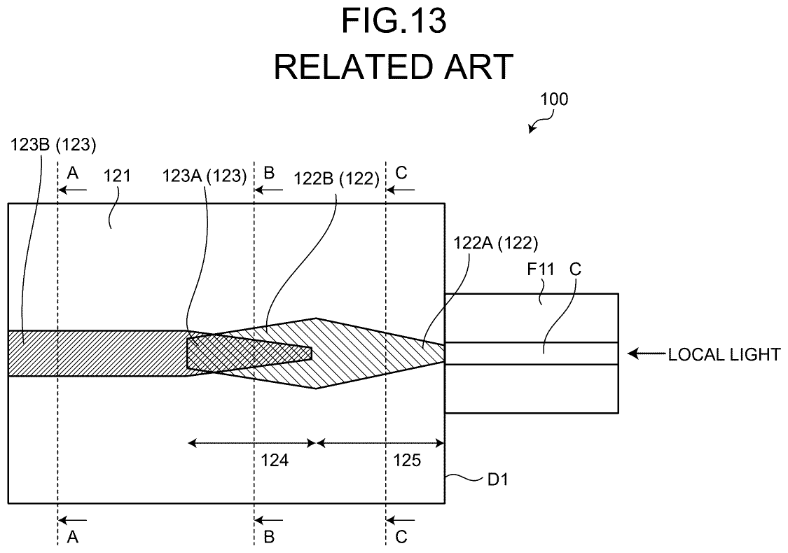

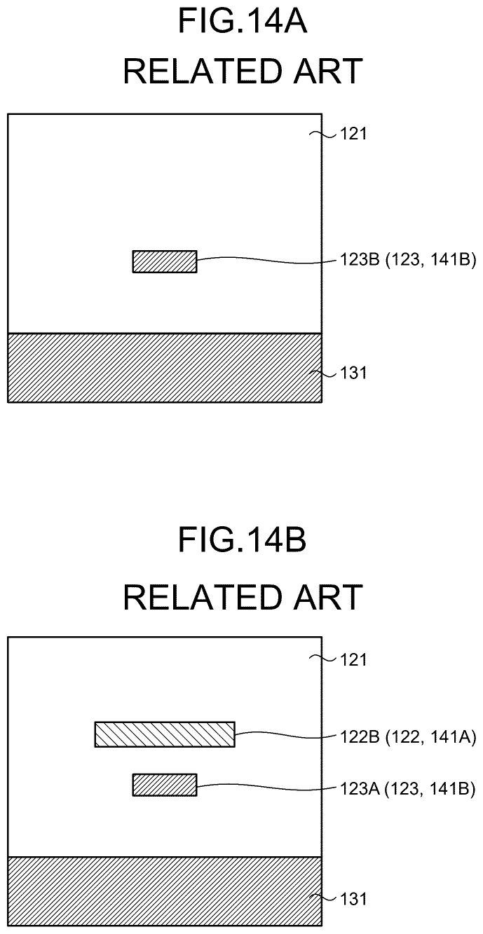

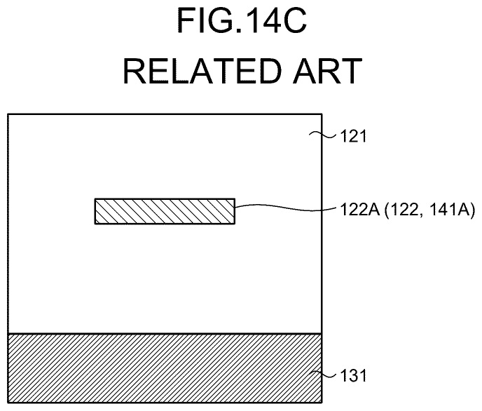

FIG. 11 is a diagram illustrating an example of an optical transceiver 70 according to an embodiment. The optical transceiver 70 illustrated in FIG. 11 is connected to an optical fiber at an output end and an optical fiber at an input end. The optical transceiver 70 has a light source 71, a digital signal processor (DSP) 72, and an optical transmitter-receiver 73. The optical transmitter-receiver 73 has an optical transmitter 73A and an optical receiver 73B. The DSP 72 is an electric component to execute digital signal processing. For example, the DSP 72 executes processing, such as encoding of transmitted data, generates an electric signal including the transmitted data, and outputs the electric signal generated, to the optical transmitter 73A. Furthermore, the DSP 72 obtains an electric signal including received data, from the optical receiver 73B, and obtains the received data by executing processing, such as decoding of the electric signal obtained.

The light source 71 includes, for example, a laser diode, generates light of a predetermined wavelength, and supplies the light to the optical transmitter 73A and the optical receiver 73B. The optical transmitter 73A modulates the light supplied from the light source 71 by using the electric signal output from the DSP 72 and outputs transmitted light obtained, to the optical fiber. The optical transmitter 73A has an optical modulator element 73A1 that generates the transmitted light by modulating the light supplied from the light source 71 by using the electric signal input to an optical modulator when the light propagates through a waveguide.

The optical receiver 73B has an optical receiver element 73B1 that receives an optical signal from the optical fiber and that subjects received light to demodulation by using the light supplied from the light source 71. The optical receiver 73B then converts the received light subjected to the demodulation into an electric signal and outputs the electric signal that has been converted, to the DSP 72. The optical receiver 73B has, built therein, an optical device of a substrate-type optical waveguide element that guides light.

The optical device has a first waveguide, and a second waveguide including a region overlapping part of the first waveguide in a vertical direction. The first waveguide has: a first tapered portion that increases in waveguide width as distance from an optical input-output portion of the optical device increases; and a second tapered portion that is connected with the first tapered portion and decreases in waveguide width as distance from the first tapered portion increases. The second waveguide has a third waveguide, and a fourth waveguide extending along the third waveguide. The second waveguide has a structure that increases in waveguide width from one end of the third waveguide and fourth waveguide, in a region overlapping the second tapered portion. The second waveguide has a structure with the third waveguide and the fourth waveguide being separate from each other in a region that is outside the region overlapping the second tapered portion and that is opposite to a region where the first tapered portion is. As a result, optical loss is able to be minimized.

Furthermore, the optical transmitter 73A may have, built therein, an optical device of a substrate-type optical waveguide element that guides light.

For convenience of description, a case where the optical transceiver 70 has, built therein, the optical transmitter 73A and the optical receiver 73B has been described as an example, but the optical transceiver 70 may have, built therein, either one of the optical transmitter 73A and the optical receiver 73B.

Furthermore, the components of each unit illustrated in the drawings may be not configured physically as illustrated in the drawings. That is, specific modes of separation and integration of each unit are not limited to those illustrated in the drawings, and all or part of each unit may be configured to be functionally or physically separated or integrated in any units according to various loads and use situations, for example.

Furthermore, all or any part of various processing functions implemented by each device may be executed on a central processing unit (CPU) (or a microcomputer, such as a micro processing unit (MPU) or a micro controller unit (MCU)). Furthermore, all or any part of the various processing functions may of course be executed on a program analyzed and executed by a CPU (or a microcomputer, such as an MPU or MCU) or on hardware by wired logic.

According to one aspect, optical loss is able to be minimized.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device comprising a first waveguide, and a second waveguide including a region overlapping part of the first waveguide in a vertical direction, wherein
the first waveguide includes:
a first tapered portion that increases in waveguide width from a start point of the first tapered portion toward an end point of the first tapered portion; and
a second tapered portion that is connected with the end point of the first tapered portion and decreases in waveguide width as distance from the first tapered portion increases, and
the second waveguide includes:
a third waveguide;
a fourth waveguide extending along the third waveguide;
a first structure in a region overlapping the second tapered portion, the first structure having the third waveguide and the fourth waveguide each increasing in waveguide width as distance from the end point of the first tapered portion increases; and
a second structure in a region that is outside the region overlapping the second tapered portion and that is opposite to a region where the first tapered portion is, the second structure having the third waveguide and the fourth waveguide separate from each other.

2. The optical device according to claim 1, wherein the first waveguide and the second waveguide are structured to be line-symmetric about a central axis of the first waveguide.

3. The optical device according to the claim 1, wherein an interval between the third waveguide and the fourth waveguide in the region overlapping the second tapered portion is constant.

4. The optical device according to the claim 1, wherein an interval between the third waveguide and the fourth waveguide in the region overlapping the second tapered portion gradually increases from the first tapered portion toward the second tapered portion.

5. The optical device according to claim 1, wherein one end of the third waveguide and one end of the fourth waveguide are arranged from the region overlapping the second tapered portion to positions separate from the first tapered portion, via a region overlapping the first tapered portion.

6. The optical device according to claim 1, wherein one end of the third waveguide and one end of the fourth waveguide are arranged from the region overlapping the second tapered portion to positions separate from the second tapered portion.

7. An optical receiver comprising an optical receiver element to convert received light into an electric signal, wherein
the optical receiver element includes an optical device having: a first waveguide; and a second waveguide including a region overlapping part of the first waveguide in a vertical direction, wherein
the first waveguide includes:
a first tapered portion that increases in waveguide width from a start point of the first tapered portion toward an end point of the first tapered portion; and
a second tapered portion that is connected with the end point of the first tapered portion and decreases in waveguide width as distance from the first tapered portion increases, and
the second waveguide includes:
a third waveguide;
a fourth waveguide extending along the third waveguide;
a first structure in a region overlapping the second tapered portion, the first structure having the third waveguide and the fourth waveguide each increasing in waveguide width as distance from the end point of the first tapered portion increases; and
a second structure in a region that is outside the region overlapping the second tapered portion and that is opposite to a region where the first tapered portion is, the second structure having the third waveguide and the fourth waveguide separate from each other.

8. An optical transmitter comprising an optical modulator element to modulate light guided according to an electric signal, wherein
the optical modulator element includes an optical device having: a first waveguide; and a second waveguide including a region overlapping part of the first waveguide in a vertical direction, wherein
the first waveguide includes:
a first tapered portion that increases in waveguide width from a start point of the first tapered portion toward an end point of the first tapered portion; and
a second tapered portion that is connected with the end point of the first tapered portion and decreases in waveguide width as distance from the first tapered portion increases, and
the second waveguide includes:
a third waveguide;
a fourth waveguide extending along the third waveguide;
a first structure in a region overlapping the second tapered portion, the first structure having the third waveguide and the fourth waveguide each increasing in waveguide width as distance from the end point of the first tapered portion increases; and
a second structure in a region that is outside the region overlapping the second tapered portion and that is opposite to a region where the first tapered portion is, the second structure having the third waveguide and the fourth waveguide separate from each other.
